(19) United States
(12) Patent Application Publication
(10) Pub. No.: US 2022/0104641 A1
(43) Pub. Date: Apr. 7, 2022

(54) Developmental Drinking Cup and Training Straw and Method of Use

(71) Applicant: eazy-PZ, LLC, Parker, CO (US)

(72) Inventor: Dawn Winkelmann, Littleton, CO (US)

(21) Appl. No.: 17/062,866

(22) Filed: Oct. 5, 2020

(51) Int. Cl. A47G 19/22; G09B 19/00; A47G 21/18

(52) U.S. Cl. CPC A47G 19/2272; A47G 19/2222; A47G 21/18; G09B 19/003

(57) ABSTRACT

A developmental drinking cup and training straw and method for developmental drinking stages is presented. A first stage presents an open-topped tiny cup, having a small volume, whereby a toddler's eye-hand and hand-to-mouth coordination is promoted while encouraging head-forward drinking which lessens choking and reinforces a strong swallow reflex. Once mastery of the initial stage is attained, an open-topped mini cup is presented, having twice the capacity of the tiny cup, to reinforce the developmental drinking promoted in the initial stage. A third and fourth stage present the mini cup in use with a training straw which inverts to present a second end after use with the first end has been mastered. Eye-hand and hand-to-mouth coordination and head-forward drinking is developed while generating confidence with independent drinking without sippy cups or spouted vessels which are known to impact speech development.

### BACKGROUND OF THE INVENTION

Development of coordination necessary for independent feeding and drinking in early childhood is critical. Open-cup drinking requires learned motor skills important for childhood development and promotes healthy oral and speech development. Further, independent feeding and drinking increases childhood confidence and is associated with better dietary health in later life.

A toddler should learn to drink from an open cup independently (with some spillage) around twelve months of age. Open cup drinking supports oral and speech development, aids with teething, and helps development of a strong swallow. Motor skills necessary for independent drinking include lip-rounding, eye-hand coordination, and proper handling of the drinking vessel to minimize spillage. Importantly, open cup drinking promotes feeding independence and may increase confidence and assist in speech development.

Sippy cups, extended bottle use, and other cups with enclosed tops that minimize mess, are frequently relied upon for convenience. But such drinking vessels may delay learned motor skills and promote incorrect drinking habits that are correlated with obesity and nutritional issues in later life. Most sippy cups require drinking with the head in a rearward position, tilted backwards, with the mouth raised. The spout may depress the tongue and promote sucking liquid through the spout as opposed to controlled tipping and sipping. This action may not be conducive to developing a correct swallowing reflex and may increase the chances of chocking. See, e.g. Keim S A, Fletcher E N, TePoel M R, and McKenzie L B, Injuries Associated with Bottles, Pacifiers, and Sippy Cups in the United States, Pediatrics, June 2012; 129(6): 1104-1110. Further, prolonged bottle feeding is associated with obesity and nutritional deficiency. See, e.g. Potera C, Prolonged Bottle Feeding Raises Childhood Obesity Risk, American Journal of Nursing: August 2011; 111(8): 17; Sutcliffe T L, Khambalia A, Westergard S, Jacobson S, Peer M, and Parkin P C, Iron Depletion is Associated with Daytime Bottle-Feeding in the Second and Third Years of Life. Archives of Pediatrics & Adolescent Medicine, 2006; 160(11): 1114-1120; and Bonuck K A and Kahn R, Prolonged Bottle Use and Its Association with Iron Deficiency Anemia and Overweight: A Preliminary Study, Clinical Pediatrics 2002; 41(8): 603-607.

Prolonged bottle feeding has been linked to a 33 percentage increase in a child's risk of obesity. See Gooze R A, Anderson S E, and Whitaker R C, Prolonged Bottle Use and Obesity at 5.5 Years of Age in US Children, Journal of Pediatrics, 2011; 159(3): 431-436.

What is needed is a developmental drinking cup and training straw and associated method of use that are devised to stimulate early development of motor skills to promote independent drinking and feeding habits, reinforce head-forward drinking, and promote a strong swallow reflex without impacting speech development.

### FIELD OF THE INVENTION

The present invention relates to a developmental drinking cup and training straw and method of use thereof. The present invention promotes the adoption of heathy feeding and drinking habits and increases development of motor coordination required in developing independent drinking and speech.

### SUMMARY OF THE INVENTION

The instant developmental drinking cup and training straw and method of use have been devised to encourage independent drinking and feeding habits and to promote development of motor coordination in early childhood.

A child begins by using an open cup, a cup without a spout to drink directly from the cup rim. This “tiny cup” is devised specifically for use by a child of around twelve (12) months of age. The tiny cup is therefore sized appropriately for handling by a toddler and is made from a rubberlike polymer for tractive engagement in the hand that is unlikely to cause harm in use by a toddler. The rubberlike polymer is also unbreakable in typical use, or when dropped. The tiny cup includes a frustoconical interior volume whereby the interior volume has a greater diameter at the cup mouth than at the cup base. The interior wall of the tiny cup is therefore sloped, inclining towards the cup base. In a preferred embodiment herein disclosed, the interior volume is adapted to hold one (1) ounce of liquid. The outer wall of the cup diverges from the rim of the mouth and thickens towards the base, presenting a lower center of gravity and a weighted base to prevent tipping. The wider diameter base increases confidence because the cup is easier to stand up between uses.

The sloped interior wall of the tiny cup provides two important features. First, the wall of the tiny cup is thicker toward the cup base than at the cup rim. This creates a weightier base and, therefore, a lower center of gravity for the cup well suited for maintaining uprightness upon a surface. Secondly, the slope of the interior wall declining from the base to the rim serves to accelerate the liquid along the sloped surface towards the rim when the cup is turned toward its side, thereby promoting head-forward posture when drinking from the cup. This helps to prevent choking and facilitates development of a strong swallow reflex. It also promotes eye-hand and hand-to-mouth coordination and fine motor skills in presenting and tipping the cup.

The volume of the tiny cup of one (1) ounce allows ease of use and coordination by a toddler (there is less mass to handle and less spillage to confront) and it reinforces portion control to prevent overindulgence and over-serving. Further, it increases communication and interaction from the child in requesting more when desired. this in turn encourages communication and increases confidence.

Starting the toddler drinking form an open cup also promotes lip-rounding, correct swallow reflex, eye-hand coordination, and motor coordination in maintaining posture to drink from the tiny cup, to thereby foster independent drinking which in turn fosters confidence.

A second stage in the developmental drinking method herein described includes switching to use of a second cup having a larger capacity than the tiny cup (which cup is herein called the “mini cup” for purposes of differentiation). In a preferred embodiment set forth herein, the mini cup is substantially similar to the tiny cup but is devised to hold two (2) ounces in its interior volume. This increased capacity promotes and reinforces further motor coordination in handling the increased volume and in drinking therefrom, further augmenting the reflexes and habits developed during the initial stage of the method set forth above.

A third stage in the developmental drinking method herein described includes use of a training straw. Use of a straw requires sucking and proper lip-rounding to engage the end of the straw an appropriate depth in the mouth. The training straw set forth herein is specifically adapted for use by toddlers to assist in development of proper drinking habits safely.

The training straw is devised to be relatively shorter than a typical straw, and of a wider diameter throughout. The stouter training straw includes a tactile marker a certain distance from a first end, whereby correct placement of the straw in the mouth is haptically signaled to a toddler. In a preferred embodiment herein disclosed, the tactile marker comprises a plurality of bumps, however any tactile marker may be employed to like effect, to haptically signal the position of the straw in the toddler's mouth. Thus grooves, ridges, lumps, bumps, indentations, protrusions, or any other change or discontinuity in the exterior surface sufficient for sensory stimulation in the mouth of a toddler is contemplated as part of this disclosure.

The training straw is adapted for use with the mini cup. A sealable lid is included, through which the training straw inserts. The training straw is contemplated to be rendered of a rubberlike polymer that is soft and yielding to the touch, such as food grade silicone. The training straw is therefore devised to minimize danger of injury in use by a toddler. The larger diameter and relatively shorter length of the straw are likewise provided to lessen chances of overextension of the straw into the toddler's mouth during use and, importantly, reduce the time the toddler needs to hold its breath in sucking liquid through the straw. In a preferred embodiment set forth herein, the first end of the straw is deflected off the vertical at an obtuse angle to facilitate use and engagement in the mouth and encourage head-forward posture when engaging the straw.

Once use of the training straw in the first position has been mastered, a toddler may be served the mini cup with the training straw in a second position as a fourth stage in the developmental drinking method herein described. The second position inverts the straw, placing the first end with the tactile marker inside the interior volume of the cup. A second end of the training straw is therefore accessible above the cup mouth for engagement in the mouth of a toddler. The second end lacks any tactile marker and, as set forth in the preferred embodiment herein, may be aligned along the longitudinal axis of the straw whereby head-forward drinking is encouraged and greater eye-hand coordination is required to properly engage the straw in the mouth. Haptic sensation of the straw's position inside the mouth is relayed via lip-rounding rather than the tactile marker disposed at the first end.

Thus four stages of developmental drinking are envisioned for use in developing independent drinking by a toddler. The tiny cup facilitates drinking from an open-mouthed container, without a spout or lid, requiring eye-hand coordination and head-forward posture to avoid spillage. The small size of the tiny cup is adapted for grasping and wielding by a toddler. The tiny cup limits portion size and encourages communication and bolsters confidence. Further, lacking any spout, head-back drinking is obviated, lessening choking hazards, and not impacting development of the palette and, therefore, speech.

Once use of the tiny cup is mastered, upgrading the tiny cup to the mini cup enables increased development as handling a larger capacity necessarily requires. Since the mini cup is provided with a training straw and associated lid, the toddler may further develop independent drinking habits by engaging the training straw—initially in the first position, to learn proper placement and oral engagement of the straw, and then in the second position once use of the training straw in the first position has been mastered. In this manner, a toddler is progressed through stages of drinking that are critical to first develop, to then augment motor coordination and proper reflexes to lessen choking, spillage, and health issues correlated with over-reliance on sippy cups and extended bottle feeding. Such development of independent drinking is further associated with better speech development, communication, and confidence in children.

Thus has been broadly outlined the more important features of the present developmental drinking cup and training straw and method of use so that the detailed description thereof that follows may be better understood and in order that the present contribution to the art may be better appreciated.

Objects of the present developmental drinking cup and training straw and method of use, along with various novel features that characterize the invention are particularly pointed out in the claims forming a part of this disclosure. For better understanding of the developmental drinking cup and training straw and method of use, its operating advantages and specific objects attained by its uses, refer to the accompanying drawings and description.

### BRIEF DESCRIPTION OF THE DRAWINGS

### Figures

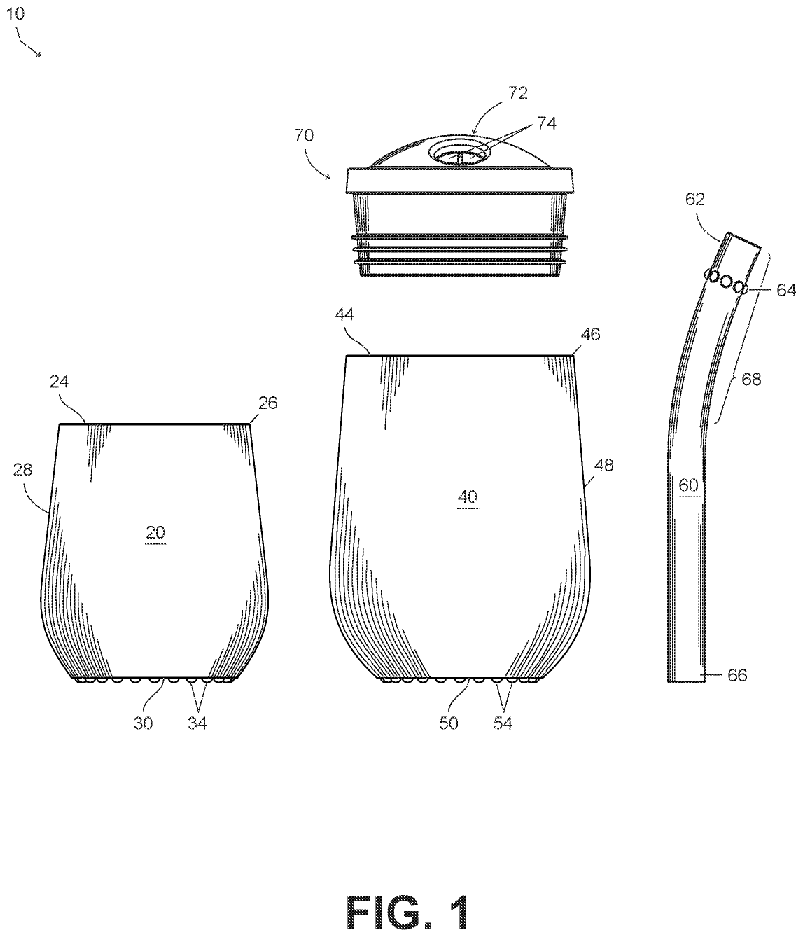

FIG. 1 is an elevation view of an example embodiment of a tiny cup, a mini cup with lid, and a straw that collectively comprise the present method and apparatus herein claimed.

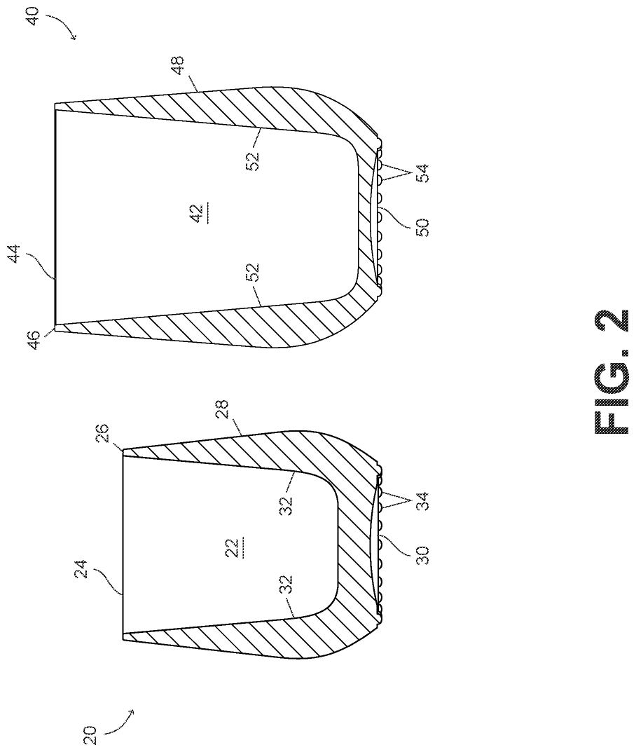

FIG. 2 is a longitudinal cross-section view of an example embodiment of the tiny cup and the mini cup showing the thickening of the cup toward the base and the angle of the sloped interior walls.

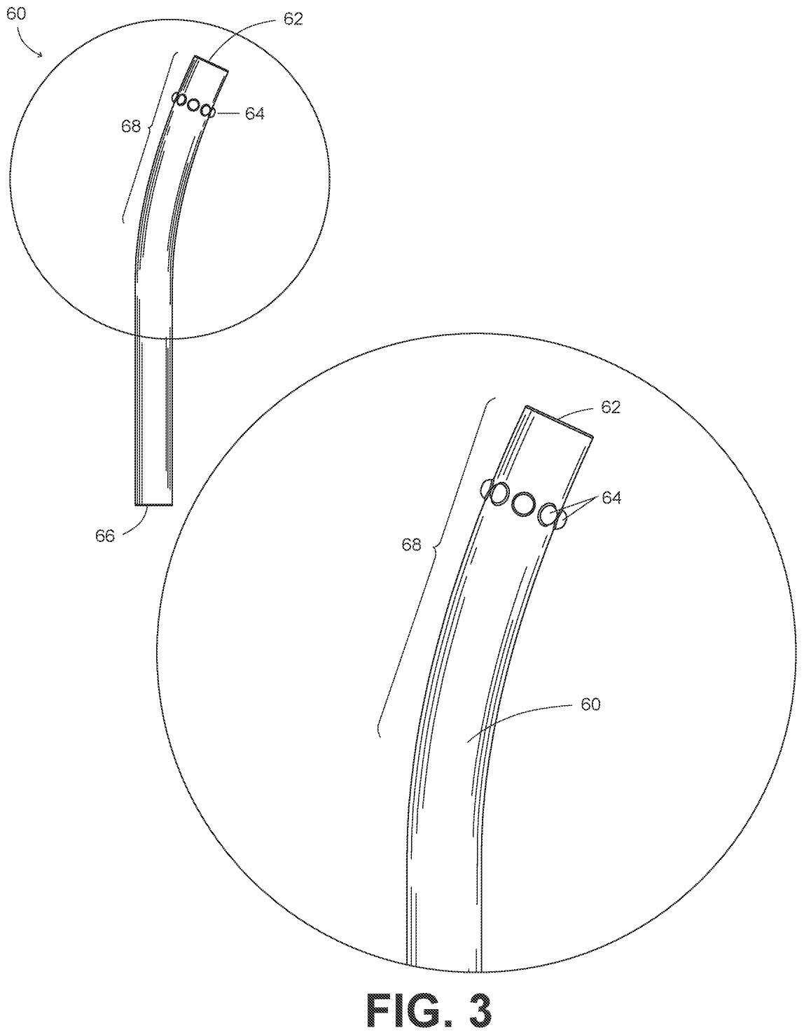

FIG. 3 is a detail view of an example embodiment of a first end of the training to straw with tactile marker evident.

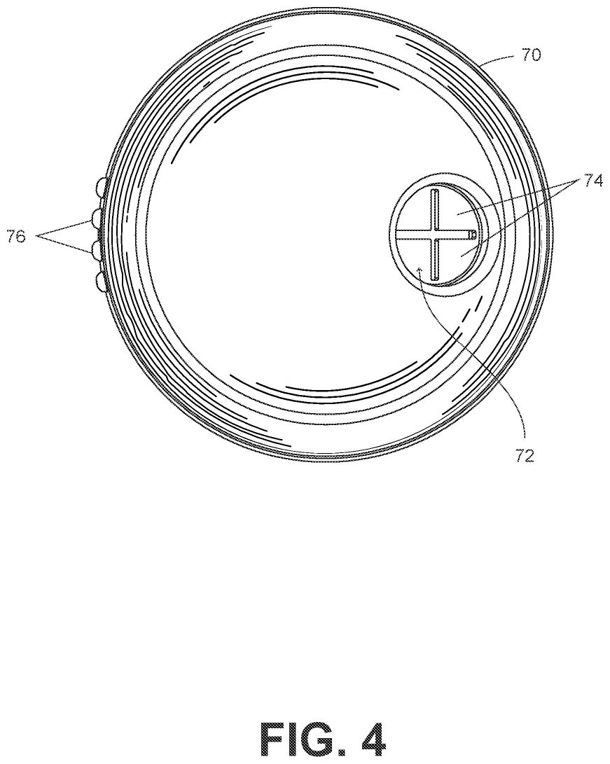

FIG. 4 is a top elevation view of an example embodiment of the lid of the mini cup.

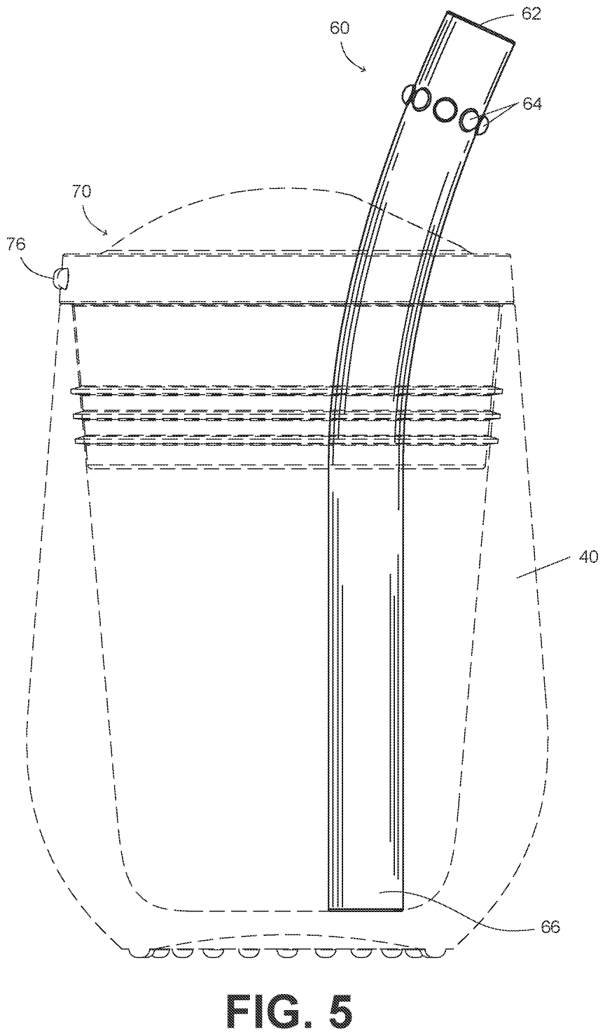

FIG. 5 is an in-use view of an example embodiment of the training straw disposed in the mini cup (illustrated in dashed lines) in a first position.

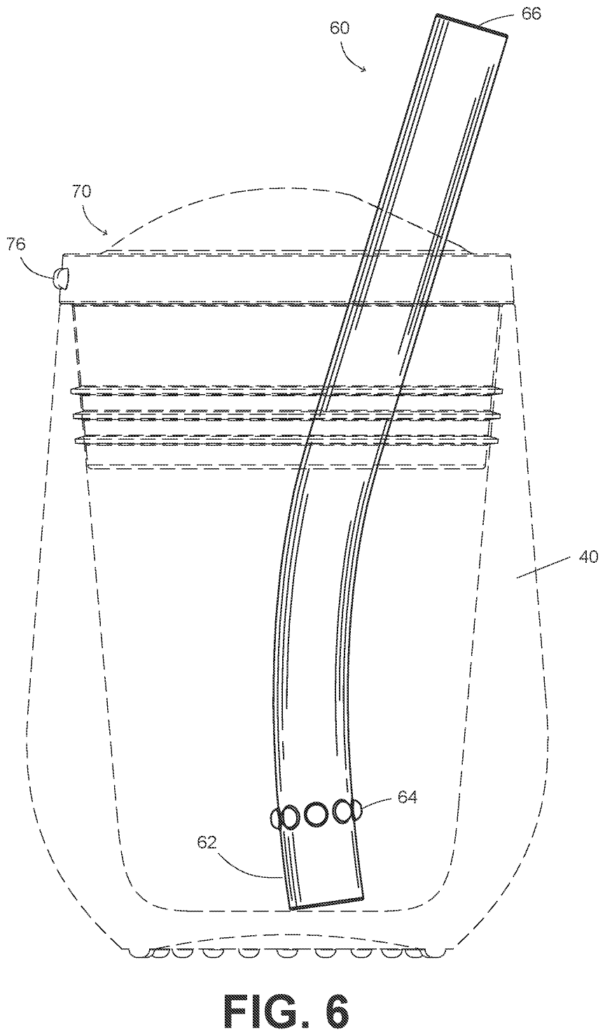

FIG. 6 is an in-use view of an example embodiment of the training straw disposed in the mini cup (illustrated in dashed lines) in a second position.

### DETAILED DESCRIPTION OF THE DRAWINGS

With reference now to the drawings, and in particular FIGS. 1 through 6 thereof, example of the instant developmental drinking cup and training straw and method of use employing the principles and concepts of the present developmental drinking cup and training straw and method of use and generally designated by the reference number 10 will be described.

Referring to FIGS. 1 through 6 a preferred embodiment of the present developmental drinking cup and training straw and method of use 10 is illustrated. Referring to FIG. 1, elevation views of example embodiments of a tiny cup 20, mini cup 40, and training straw 60 are provided. Tiny cup 20 is configured to house an interior volume of one ounce (1 oz). Outer wall 28 narrows toward mouth 24. However, interior volume 22 (see FIG. 2) narrows toward base 30, thereby thickening outer wall 28 and lowering the cup's 20 center of gravity. Tiny cup 20 is contemplated as the first stage in the developmental drinking method herein set forth, encouraging one-year-olds to drink directly from the cup 20 mouth 24 without need of an enclosed top or spout as is common with “sippy-cups” presently seen in the art.

Mini cup 40 is also shown in side elevation view. Mini cup 40 encloses twice the volume compared to tiny cup 20 and includes sealable lid 70. Mini cup 40 is used in the second stage of the instant developmental drinking method set forth herein, providing a larger capacity and larger circumference for use by older toddlers. Similar to tiny cup 20, mini cup 40 has an outer wall 48 that widens toward base 50. Also similar to tiny cup 20, mini cup 40 includes sloped interior wall 52 whereby interior volume 42 narrows toward the base 50 (see FIG. 2). Such a configuration assists in maintaining head-forward drinking (as set forth above) and the development of eye-hand and hand-to-mouth coordination as well as reinforcing the swallow reflex while reducing risks of choking. Sealable lid 70 is installable into mini cup 40 for use with training straw 60, shown in side elevation view in FIG. 1, which is releasably insertable into aperture 72 disposed in sealable lid 70. Training straw 60 is envisioned for use in the third and fourth stages of the developmental drinking method set forth herein. In the third stage, training straw 60 is contemplated for use in a first position, with first end 62 upright. In the fourth stage, training straw 60 is contemplated for use in a second position, with second end 66 upright, as will be set forth herein below.

Training straw 60 includes tactile marker 64 at first end 62. Tactile marker 64 is here represented as a plurality of raised bumps that signal position of the straw 60 interior to a toddler's mouth and thereby prevent overextension of the straw 60 into the mouth by the toddler during use, however it should be noted that any tactile marker 64 capable of signaling position of first end 62 interior to the mouth of a toddler is contemplated as within scope of this invention 10. First end 62 of training straw 60 includes deflection 68 to further encourage and assist in development of head-forward drinking.

Once a child has mastered use of training straw 60 in the first position, training straw 60 is invertible so that tactile marker 64 is no longer presented into the mouth of the user. Instead, first end 62 maybe inserted into sealable lid 70 and, alternatively, training straw 60 may be used with mini cup 40 without sealable lid 70 attached.

It should be noted that training straw 60 is relatively shorter and has a relatively larger diameter than a standard drinking straw. These stouter dimensions present a straw 60 more easily handled by a toddler. Further, the relatively larger diameter assists in the development of a strong swallow reflex, while the relatively shorter length makes eye-to-mouth coordination of the straw easier. In the example embodiment illustrated herein, training straw 60 is not more than 09 millimeters long and has a diameter of not less than 9 millimeters. Tactile marker 64 is disposed not more than 10 millimeters from first end 62. Deflection 68 originates approximately halfway along length of straw 60, and deflects first end 62 not more than 25° off of the vertical.

In a preferred embodiment, tiny cup 20, mini cup 40, sealable lid 70, and training straw 60 are manufactured from a rubberlike polymer, such as food grade silicone. As such, the outer surfaces of the tiny cup 20, mini cup 40, sealable lid 70, and training straw 60 are rubberlike and tactile, resilient and yielding to prevent breakage when dropped or injury when forcibly contacting the body, and firm enough for use as intended.

FIG. 2 illustrates longitudinal cross-sections of each of tiny cup 20 and mini cup 40 to expose frustoconical interior volumes 22, 42 and widening walls 28, 48 that create a lower center of gravity of each said tiny and mini cup 20, 40. Interior sloped walls 28, 48 incline from a maximum inner diameter of each cup 20, 40 at the mouth thereof to a minimum inner diameter proximal the base thereof. Similarly, outer walls 28, 48 thicken from the mouth of each cup 24, 44 toward bases 30, 50, with maximum thickness expressed proximal bases 30, 50. Bases 30, 50 include a plurality of protrusions 34, 54 projected therefrom in a circular pattern around the circumference of each said base 30, 50. This plurality of protrusions 34, 54 provides increased tractive engagement of each said cup 20, 40 when positioned upright upon a surface.

The sloped interior walls 32, 52, inclining toward each base 30, 50, present a declining slope toward each said cup's mouth 24, 44 when each respective cup 20, 40 is upended. The sloped interior walls 32, 52 therefore present a gradient down which liquid held in the cup 20, 40 is accelerated when the cup 20, 40 is tipped for drinking. Such a configuration assists in developing head-forward drinking, the development of a strong swallow reflex, and improved eye-hand and hand-to-mouth coordination.

FIG. 3 illustrates training straw 60 in side elevation view, with detail inset for showing tactile marker 64 disposed proximal first end 62. In this example embodiment depicted, tactile marker 64 is disposed 10 mm from first end 62. Tactile marker 64 signals position of first end 62 of training straw 60 in the mouth of a user. Tactile marker 64 thus assists in preventing over insertion of training straw 60 first end 62 into the mouth. Training straw 60 is shown as 109 mm along outer length and 106 mm along inner length. This is approximately half the length of a standard drinking straw (typically approximately 216 mm long). Training straw 60 is also not more than 9 mm outer diameter and 6 mm inner diameter (and therefore 3 mm thick). A standard drinking straw is typically approximately 6.1 mm outer diameter, 5.8 mm inner diameter, and only 0.3 mm thick. This stouter configuration of training straw 60 assists developmental drinking by requiring stronger lip closure around the straw 60 circumference and promotes easier handling by a toddler. The shorter straw 60 also allows drawing fluid into the mouth in less time, reducing the amount of time a toddler needs to hold its breath during use. Further, deflection 68 presents first end anteriorly deflected not more than 25° off the vertical to encourage head-forward drinking.

In the third stage of the developmental method set forth herein, training straw 60 is used in conjunction with mini cup 40 and sealable lid 70 shown in FIG. 4. Sealable lid 70 is configured for removable engagement into mouth of mini cup 40 and presents aperture 72 with sealing skirt 74 for engagement with training straw 60 and to lessen spillage through the aperture 72 should the cup 40 be tipped over. Sealable lid 70 further includes tactile marker 76 disposed upon the exterior surface diametrically opposed relative to aperture 72. Tactile marker 76 assists a toddler grasping the cup orient the cup by haptically signaling the orientation of the cup relative the toddler when the toddler grasps the cup 40.

Training straw 60 is insertable into aperture 72 in sealable lid 70 (see FIGS. 4 through 6) in each of a first position and a second position. The third stage of the developmental drinking method set forth herein employs training straw 60 in the first position. As shown in FIG. 5, training straw 60 in the first position presents first end 62 to the user and tactile marker 64 is employed to signal position of first end 62 interior to the user's mouth. Further, deflection 68 presents first end 62 forwards for easier engagement by the user without tipping of the cup 40 forward or tilting the head downwards. Once use of the straw 60 has been mastered in the first position, stage four of the present method employs training straw 60 in the second position, with second end 66 exposed for use absent tactile marker 64 (see FIG. 6).

Thus a user is encouraged to progress through four stages of developmental drinking, learning eye-hand and hand-to-mouth coordination as well as developing a strong swallow reflex while reducing risks of choking. Further, use of straw 60 from the first position to the second position encourages learning how to use a straw correctly.

1. A developmental drinking and training apparatus comprising:
a training straw having a first end and a second end, said training straw further comprising a tactile marker disposed a specific distance from the first end; and
a cup having an attachable lid, said lid including an aperture for sealable engagement with the training straw;
wherein the training straw is invertible in use between a first position and a second position whereby the first position teaches correct engagement of the first end of the straw in the mouth of a user by haptically signaling contact with the tactile marker and whereby the second position enables the user to use the straw without the tactile marker engaged in the user's mouth.

2. The developmental drinking and training apparatus of claim 1 wherein the training straw further includes a deflection proximal the first end.

3. The developmental drinking and training apparatus of claim 1 wherein the tactile marker is a plurality of bumps.

4. The developmental drinking and training apparatus of claim 1 wherein the training straw is made out of a rubberlike polymer.

5. The attachable lid of claim 1 wherein the aperture comprises a sealing skirt adapted to sealably engage around the straw.

6. The developmental drinking and training apparatus of claim 1 wherein the cup includes an outer wall that thickens toward the base.

7. The training straw of claim 1 wherein the tactile marker is disposed between 8 millimeters and 12 millimeters from the first end.

8. The training straw of claim 2 wherein the deflection is an obtuse angle of not more than 25° off of the vertical.

9. The developmental drinking and training apparatus of claim 4 wherein the training straw is not more than 109 millimeters in length.

10. The developmental drinking and training apparatus of claim 4 wherein the training straw is not less than 6 millimeters in inner diameter.

11. The developmental drinking and training apparatus of claim 5 wherein the cup includes an interior volume that narrows toward the base, wherein a frustoconical cross-section supports head-forward drinking.

12. The developmental drinking and training apparatus of claim 6 wherein the interior volume is 1 ounce.

13. The developmental drinking and training apparatus of claim 6 wherein the interior volume is 2 ounces.

14. The developmental drinking and training apparatus of claim 10 wherein the training straw is not less than 9 millimeters in outer diameter.

15. The developmental drinking and training apparatus of claim 11 wherein the interior slope of the cup is approximately 10.

16. A method of developmental drinking for infants and toddlers, said method comprising the steps of:
serving beverages to a toddler in a tiny cup, said tiny cup comprising:
a base;
a mouth that is smaller in diameter than the base;
a 1 ounce frustoconical interior volume surrounded by a sloped inner wall that inclines toward the base;
an outer wall that thickens toward the base;
wherein eye-hand and hand-to-mouth and head-forward drinking is promoted;
once mastery of the tiny cup has been attained, serving beverages to the toddler in a mini cup, said mini cup comprising:
a base;
a mouth that is smaller in diameter than the base;
a 2 ounce frustoconical interior volume surrounded by a sloped inner wall that inclines toward the base;
an outer wall that thickens toward the base;
wherein eye-hand and hand-to-mouth and head-forward drinking is reinforced by developing mastery of a cup having twice the capacity of the tiny cup;
once mastery of the mini cup has been attained, serving beverages to the toddler in the mini cup with a sealable lid engaged within the mouth of the mini cup, said sealable lid adapted for insertion of a training straw through an aperture therein disposed, said training straw disposed in a first position with a first end uppermost, said training straw comprising:
a tactile marker disposed proximal the first end, said tactile marker configured to haptically signal position of the first end interior to the mouth of the user and thereby discourage over insertion of the first end into the user's mouth;
a deflection deflecting the first end off of the vertical;
wherein eye-hand, hand-to-mouth coordination and head-forward drinking are reinforced to further promote development of a strong swallow reflex; and
once mastery of the mini cup with training straw in the first position has been attained, serving beverages to the toddler in the mini cup with the training straw disposed in the second position, inverted relative the first position, whereby a second end of the training straw is presented for drinking by;
wherein the tiny cup, mini cup, and training straw are usable in tandem to provide a graduated series of stages promoting and reinforcing eye-hand and hand-to-mouth coordination, head-forward drinking, and the development of a strong swallow reflex without impacting speech development or growth of the soft palette.
